(19) United States
(12) Patent Application Publication
(10) Pub. No.: US 2006/0132311 A1
(43) Pub. Date: Jun. 22, 2006

(54) Systems and methods for tracking containers

(75) Inventors: James Robert Kruest, San Diego, CA (US); Francisco Martinez de Valesco Cortina, Col. Hipodromo (MX)

Correspondence Address: BAKER & MCKENZIE LLP;PATENT DEPARTMENT, 2001 ROSS AVENUE, SUITE 2300, DALLAS, TX, 75201, US

(73) Assignee: Neology, Inc., San Diego, CA (US)

(21) Appl. No.: 11/270,067

(22) Filed: Nov. 9, 2005

Related U.S. Application Data
(60) Provisional application No. 60/626,763, filed on Nov. 9, 2004.

(51) Int. Cl. G08B 13/14

(52) U.S. Cl. 340/572.4; 340/5.9; 340/572.8; 235/375; 340/5.8

(57) ABSTRACT

RFID tags can be deployed in such a manner as to deter, or even prevent loss of inventory. For example, by associating an RFID tag with each container of a certain alcoholic beverage, pharmaceutical, etc. each container can be tracked for a variety of purposes over the life of the container; including, e.g., tracking each container in the warehouse to prevent loss of inventory, verifying that containers have been imported properly, and verifying that requisite taxes have been paid. A tag can be associated with a container using various techniques, including, e.g., affixing the tag to the surface of the container, imbedded it in the material of the container, embedding the tag in a label affixed to the container, or affixing or embedding it in a bottle cap. The RFID Tag can be used with metal when a dielectric is selected to isolate the RFID tag from the metal.

This application claims priority to U.S. Provisional Application No. 60/626,763 filed on Nov. 9, 2004, which is incorporated here by reference in its entirety.

### BACKGROUND

1. Field of the Invention

The field of the invention relates generally to Radio Frequency Identification (RFID) and more particularly to tracking containers, such as bottles containing beverages, foods, or pharmaceuticals, in order to prevent counterfeiting, theft, tax evasion, and loss of inventory.

2. Background Information

Some countries have problems with theft and counterfeiting of consumer products such as alcoholic beverages, pharmaceuticals, etc. Theft and counterfeiting is costly to the manufacturers, distributors, and retailers of consumer products, reducing profits, increasing costs, and impacting the consumer's perception of the quality of the product. Additionally, when consumer products are counterfeited, consumers are defrauded. A related problem is the illegal importing of, e.g., alcoholic beverages, pharmaceuticals, etc. Illegal imports may cut into the legal importer business, again lowering profits, and potentially increasing costs due to money spent fighting the problem. Additionally, in many cases, taxes may not have been paid on illegally imported alcoholic beverages, pharmaceuticals, etc. depriving local governments out of needed revenue. Determining if taxes have been paid on legally imported consumer products and pharmaceuticals can also be an issue for producers, importers, distributors, and government agencies tasked tax collection.

Bar codes can be used to help track inventory, such as beverage and/or pharmaceuticals containers; however, bar code systems have many draw backs. A primary draw back is the fact that bar code systems are line of sight systems that require a human operator to be in relatively close proximity to the bar code in reader to read it. Thus, tracking large amounts of containers, especially when they are moving form facility to facility and even form country to country, can be very labor intensive and prone to human error. The line of sight nature of bar code systems also makes it difficult to track individual containers when they are packaged, or bundled, in groups.

RFID tags do not suffer from the same drawback. RFID systems are not line of sight, RFID tags can be read at a greater distance, and can be read even when, e.g., a container is packaged with a plurality of other containers. Further, information can be written to RFID tags after they are deployed, unlike bar codes.

### SUMMARY

RFID tags can be deployed in such a manner as to deter, or even prevent, theft, counterfeiting, illegal importation, tax avoidance, and loss of inventory. For example, by associating an RFID tag with each container of a certain alcoholic beverage, pharmaceutical, etc. each container can be tracked for a variety of purposes over the life of the container. First, the tag can be used to track each container in the warehouse to prevent loss of inventory. Similarly, enforcement officials can verify that containers have been imported properly and all requisite taxes paid via an RFID tag associated with the container. A tag can be associated with a container, such as a bottle, using various techniques, including, affixing the tag to the surface of the container, imbedded it in the material of the container, embedding the tag in a label affixed to the container, or affixing or embedding it in, for example, a bottle cap. The RFID Tag can be used with metal when a dielectric is selected to isolate the RFID tag from the metal.

These and other features, aspects, and embodiments of the invention are described below in the section entitled “Detailed Description.”

### BRIEF DESCRIPTION OF THE FIGURES

Features, aspects, and embodiments of the inventions are described in conjunction with the attached drawings, in which:

FIG. 1 is a diagram illustrating an example container fitted with an RFID tag for tracking;

FIG. 2 is a diagram illustrating an example container fitted with an RFID tag for tracking the container between a warehouse and a retail outlet;

FIG. 3 is a flowchart illustrating an example of a method of tracking bottles of alcohol that are imported into a given country;

FIG. 4 is a diagram illustrating an example method of associating a tag with a container;

FIG. 5 is a diagram illustrating an example method of associating a tag with a container;

FIG. 6 is a diagram illustrating an example method of associating a tag with a container;

FIG. 7 is a diagram illustrating an example method of associating a tag with a container; and

FIG. 8 is a diagram illustrating an example container tracking system.

### DETAILED DESCRIPTION

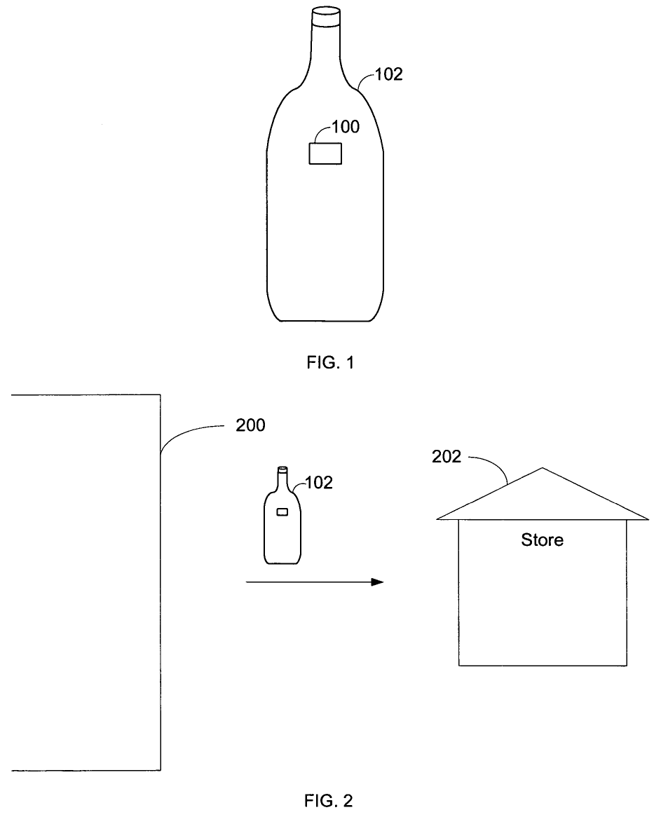

FIG. 1 is a diagram illustrating an example container 102 fitted with an RFID tag 100 for tracking in accordance with one embodiment of the systems and methods described herein. RFID tags 100 can be deployed in such a manner as to deter, or even prevent, theft, counterfeiting, illegal importation, tax avoidance, and loss of inventory. For example, by associating an RFID tag 100 with each container 102 of a certain alcoholic beverage, pharmaceutical, etc. each container 102 can be tracked for a variety of purposes over the life of the container 102. First, tag 100 can be used to track each container 102 in the warehouse to prevent loss of inventory. Systems and methods for tracking inventory in a warehouse are disclosed in U.S. patent application Ser. No. 10/658,016, entitled “Systems and Methods for Tracking the Location of Items within a Controlled Area,” filed Sep. 8, 2003, which is incorporated herein by reference in its entirety as if set forth in full. Methods for configuring a warehouse so that RFID tags can be used to track inventory is disclosed in U.S. patent application Ser. No. 10/658,634, entitled “Systems and Methods for Configuring a Warehouse for Tracking the Locations of Items Within a Controlled Area,” filed Sep. 8, 2003, which is also incorporated herein by reference in its entirety as if set forth in full.

Using, for example, the systems and methods described in the above patents, loss of inventory can be prevented. FIG. 2 is a diagram illustrating an example container 102 fitted with an RFID tag 100 for container tracking between a warehouse 200 and a retail outlet 202 in accordance with one embodiment of the systems and methods described herein. The containers 102 of FIG. 1 can be tracked as they leave the warehouse 200 and when they arrive at their destination 202, e.g., a retail outlet. When the containers 202, such as bottles containing alcoholic beverages, pharmaceuticals, etc. arrive at the destination 202, the IDs associated with them via the tags 100 can also be checked, e.g., against a database, to ensure that they are authentic. In this manner, counterfeiting can be prevented. The container 102 can, for example, be checked for authenticity by the distributor, a retail outlet operator, or enforcement officials.

Similarly, enforcement officials can verify that containers 102 have been imported properly and all requisite taxes paid via an RFID tag 100 associated with the container 102. Again, this can be done by checking the ID associated with container 102 via the tag 100 against a database. Alternatively, when the container passes through customs and/or taxes are paid, information can be written into the tag 100. This data can then be read out at a later time in order to verify the container 102.

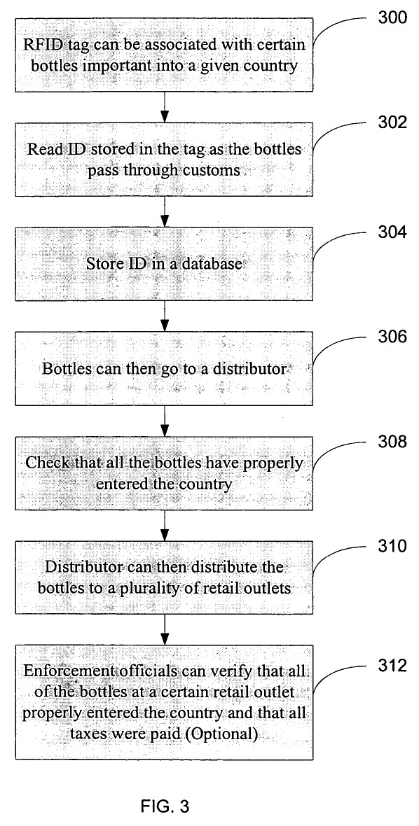

FIG. 3 is a flowchart illustrating an example of a method of tracking, e.g., alcohol imported into a given country in accordance with one embodiment of the systems and methods described herein. An RFID tag can be associated with certain bottles of, for example, premium alcohol that are important into a given country in step 300. As the bottles pass through customs, an ID stored in the tag can be read in step 302 and stored in a database in step 304, indicating that the bottle has properly passed through customs and that all appropriate taxes have been paid. The bottles can then go to a distributor in step 306 who can check that all the bottles have properly entered the country in step 308. The distributor can then distribute the bottles to a plurality of retail outlets in step 310. At a later time, enforcement officials can, if required, verify that all of the bottles at a certain retail outlet properly entered the country and that all taxes were paid, step 312. In another example, food items, and/or pharmaceuticals can be tracked using the same or similar systems and methods. Further, other types of container can be used.

RFID tags can also help deter theft by allowing a mechanism to identify potential stolen containers. Thus, theft and counterfeiting of alcoholic beverages, pharmaceuticals, etc., can be prevented, lowering costs to the manufacturers, distributors, and retailers of alcoholic beverages. RFID tags can also help keep consumer perception of quality high by lowering incidence of counterfeiting.

The use of RFID tags can also, as explained, lower illegal importing by tracking legitimate imports and verifying that, e.g., alcoholic beverages in commerce within a country are legal, e.g., illegally imported alcoholic beverages will generally either not have an RFID tag, or the RFID tag that the illegally imported alcohol has will not match the records of the manufacturer, importer, retailer, customs, etc. By using RFID tags the profits of legal importers can, in some cases, be maintained and the costs associated with countering illegal imports can be decreased. Additionally, by lowering the incidents of illegally imported alcoholic beverages, tax revenues can be increased. RFID tags can also facilitate determining if taxes have been paid.

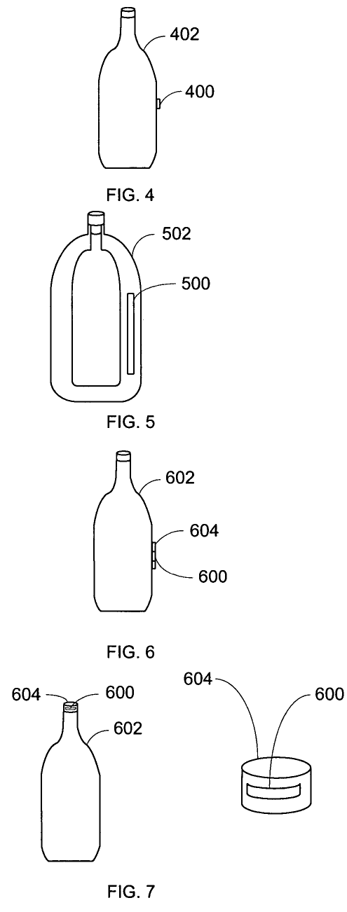

A tag can be associated with a container, such as a bottle, using various techniques. FIG. 4 is a diagram illustrating an example method of associating a tag 400 with a container 402 in accordance with one embodiment of the systems and methods described herein. In this embodiment, for example, tag 400 can simply be affixed to the surface of the container 402, e.g., the surface of a bottle. Tag 400 can be affixed, for example, using adhesives. It will be understood that generally an adhesive should be selected that will allow tag 400 to adhere to container 402 without falling off during handling, transit, etc.

FIG. 5 is a diagram illustrating an example method of associating a tag 500 with a container 502 in accordance with one embodiment of the systems and methods described herein. Tag 500 can be imbedded within the material of the container 502. For example, container 502 can be a glass bottle and tag 500 can be within a side wall of container 500. Embedding tag 500 within container 502 can make it difficult, if not impossible to remove tag 500 without damaging the bottle, making loss of tag 500 or tampering with tag 500 more difficult.

FIG. 6 is a diagram illustrating an example method of associating a tag 600 with a container 602 in accordance with one embodiment of the systems and methods described herein. For example, if the container 602 is a glass bottle, the tag 600 can be in a label 604 affixed to the bottle. It will be understood that RFID tags can, in many cases be fairly flat. This generally flat cross section can allow tag 600 to be embedded in label 604. Further, it will be understood that FIG. 6, as well as the other figures are intended to illustrate example placements of tags 400, 500, 600, and 700. Tags 400, 500, 600, and 700 are not intended to be to scale. For example, tag 600 and label 604 are drawn thicker than would generally be expected relative to the size of the bottle.

FIG. 7 is a diagram illustrating an example method of associating a tag 700 with a container 702 in accordance with one embodiment of the systems and methods described herein. The tag 700 can be affixed to, or embedded in the bottle cap 704. Tag 700 can be affixed to the outside of bottle cap 704, as shown, for example. Alternatively, tag 700 can be affixed to the top of bottle cap 704, to the inside, etc. In another embodiment, tag 600 can be embedded within bottle cap 700, similar to how tag 500 can be embedded within bottle 502 in FIG. 5.

It will be appreciated that the dielectric constant of the material that RFID tag 400, 500, 600, and 700 is attached to will need to be considered in each implementation, in order to ensure proper operation of the transceiver circuitry. For example in an embodiment with an RFID tag 400, 500, 600, and 700 embedded in a glass container the dielectric constant of the glass should be considered. Cap 704 will often be conductive. Accordingly, when RFID tag 700 is incorporated into metal cap 704 a dielectric should be placed between the metal and the tag. Additionally, any shielding properties of the metal can be considered.

Examples involving alcoholic beverages contained within glass bottles have been discussed. It will be understood that other containers can be used. Additionally, other food items can be tracked using RFID tags. RFID tags can be attached to glass bottles, plastic container, boxes, etc. Additionally, the RFID Tag can be used with metal when a dielectric is selected to isolate the RFID tag from the metal.

In certain embodiments, a hologram can be included with an RFID tag, e.g., as part of a label on a bottle, to increase security. For example, in most cases, it is unlikely that the end consumer will be able to read an RFID tag. In these cases, the RFID tag can provide the benefits described above and the hologram allows the consumer to have some confidence that the alcoholic beverage is not counterfeited and/or illegally imported for example.

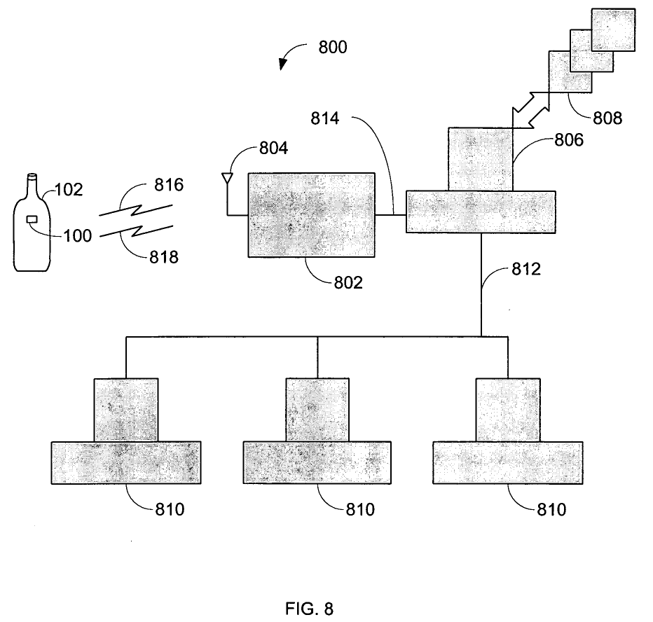

FIG. 8 is a diagram illustrating a system 800 that could be configured track a container 102 for the various purposes described above in accordance with one embodiment of the systems and methods described herein. System 800 comprises a reader or interrogator 802 that is configured to transmit an RF signal 816 via antenna 804. As will be understood, when RF signal 816 is impinged upon RF ID tag 100, tag 100 can be configured to backscatter modulate RF signal 816 with information, e.g., identifying container 102 and potentially other information, and transmit a backscatter modulated signal as a return signal 818. Return signal 818 can also be received by antenna 804 and decoded by interrogator 802. It will be understood that RF ID tag 100 can be a passive tag or an active tag depending on the embodiment; however, it will be clear that passive tags due to their smaller size and lighter weight can often be more preferable for application onto bottles and containers as described above.

U.S. Pat. No. 5,856,788 (the '788 patent), which is incorporated herein in its entirety as it set forth in full, describes a communications protocol for communications between an interrogator 802 and a tag 100. Advantageously, the protocol disclosed in the '788 patent enables identification of a particular item, e.g., a bottle 102, from among a plurality of items within range of RF signal 816. It will be understood, however, that other communication protocols exist and can be used in accordance with the systems and methods described herein.

Thus, when an item, such as bottle 102, is being tracked, it can be made to pass within a range of interrogator 802. Interrogator 802 can access information from tag 100 related to bottle 102. This information can include an identifier identifying bottle 102, as well as other information such as whether taxes have been paid, whether the item entered the country legally, when the item entered the country or left a factory, etc. The information extracted from tag 100 can then be passed to a server 806, which can be configured to store the information in one or more databases 808.

Depending on the embodiment, server 806 can be co-located with interrogator 802. Alternatively, server 806 can be located remotely from interrogator 802. Thus, the network link 814 over which information is passed from interrogator 802 to server 806 can be a Local Area Network (LAN), a Personal Area Network (PAN), a Wide Area Network (WAN), or some combination thereof. Further, network link 814 can comprise wireless links as well as terrestrial links or some combination thereof. In certain embodiments, link 814 can comprise the internet.

Further, in certain embodiments tag 100 can be a read/write tag, which can therefore allow information to be written back to tag 100. Thus, information such as the date and/or time the tag was scanned by reader 802 can be recorded on tag 100. As can other information such as whether taxes, or import duties, have been paid for bottle 102. All of these information can then be stored in one or more databases 808.

The information in databases 808 can be accessed via a network link 812. Again, network link 812 can comprise a LAN, PAN, WAN, the internet, etc., and can be co-located with server 806 and/or reader 802, or terminal 810 can be remote from server 806 and/or reader 802. Thus, information related to bottle 102 can be called up from databases 808 and used to verify, e.g., the organ of bottle 102, whether taxes and duties have been paid, the date the bottle entered the country or left off the warehouse, etc.

In certain embodiments, bottle 102 pass several reader 802 on its way to its destination. Each reader 802 can store information related to bottle 102 and databases 808 and, depending on the embodiment, to write information to tag 100 that can be recalled in the future by another interrogator 802

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed is:

1. The method for identifying a counterfeit item, comprising:
associating an identifier with each of the plurality of items;
associating an RFID tag with each of the plurality of items;
storing one of the plurality of identifier in each of the plurality of RFID tags;
distributing the items to one or more destinations;
extracting the plurality of identifiers from the RFID tags at the one or more destinations;
comparing the extracted identifiers to a list of known identifiers; and
if one of the identifiers does not match any of the identifiers in the known list, identifying the associated item as a counterfeit.

2. The method of claim 1, wherein the items are alcoholic beverages.

3. The method of claim 1, wherein the items are pharmaceuticals.

4. The method of claim 1, wherein the items are food items.

5. The method of claim 1, wherein associating an RFID tag with an item comprises affixing the RFID tag to the surface of the item.

6. The method of claim 1, wherein associating an RF ID tag with an item comprises embedding the RFID tag within the material comprising a container associated with the item.

7. The method of claim 1, wherein associating an RFID tag with an item comprises embedding the RFID tag within a label affixed to the item.

8. The method of claim 1, wherein associating an RFID tag with an item comprises embedding the RFID tag in a container load associated with the item.

9. The method of claim 8, wherein embedding the RFID tag in the container that further comprises placing a dielectric between the RF ID tag and the material comprising the container load.

10. The method of claim 1, further comprising scanning the RFID tags prior to distributing the items and storing information related to the items in a database.

11. The method of claim 10 further comprising, for each of the plurality of items, storing the date the RFID tag associated with the item was scanned prior to distribution.

12. The method of claim 10, further comprising, for each of the plurality of items, storing the time the RFID tag associated with the item was scanned prior to distribution.

13. The method of claim 1, further comprising writing information into the plurality of RFID tags prior to distribution of the items.

14. The method of claim 13, wherein, for each of the plurality of items, a destination associated with the item is written into the RFID tag associated with the item before distribution of the item.

15. The method of claim 1, further comprising, for each of the plurality of items, extracting other information from the RFID tag associated with the item at the destination.

16. The method of claim 15, wherein the date the item was distributed is extracted from the RFID tag associated with the item at the destination.

17. The method of claim 15, wherein the time the item was distributed is extracted from the RFID tag at the destination.

18. The method of claim 15, an intended destination is extracted from the RFID tag at the destination.

19. The method of claim 1, further comprising, for each of the plurality of items, extracting at destination information related to the item from a database, wherein the data was stored in the database before the item was distributed or while the item was on route to the destination.
